(19) United States
(12) Patent Application Publication
(10) Pub. No.: US 2025/0214473 A1
(43) Pub. Date: Jul. 3, 2025

(54) Charging a Vehicle According to an Optimized Charging Scheme

(71) Applicant: SPEED CHARGE, LLC, Carter Lake, IA (US)

(72) Inventors: Jamshed Nabizada, Fremont, CA (US); Nayana Sampangi, Fremont, CA (US)

(21) Appl. No.: 19/007,397

(22) Filed: Dec. 31, 2024

Related U.S. Application Data
(60) Provisional application No. 63/616,749, filed on Dec. 31, 2023.

(51) Int. Cl. B60L 53/63; B60L 53/53; B60L 53/62; B60L 53/66

(52) U.S. Cl. CPC B60L 53/63; B60L 53/53; B60L 53/62; B60L 53/66; B60L 2240/72; B60L 2260/44

(57) ABSTRACT

A charging system comprises a local energy storage disposed at a charging site; an electric coupling configured to provide an electrical interconnect between the charging site and an electric vehicle (EV); and one or more controllers configured to: (i) detect a condition related to availability of electrical energy at the charging station, (ii) in response to the detecting of the condition: (a) estimate a number of EVs to which a charge remaining at the local energy storage is to be distributed within a certain time interval, (b) initiate a charging session for transferring electric energy from the local energy storage to the EV, via the electric coupling, and (c) limit an amount of electrical energy in the charging session in view of at least the estimated number of EVs.

### REFERENCE TO RELATED APPLICATION

This application claims priority to and the benefit of the filing date of provisional U.S. Patent Application No. 63/616,749 entitled “Charging a Vehicle According to an Optimized Charging Scheme” filed on Dec. 31, 2023. The entire content of the provisional application is hereby expressly incorporated herein by reference

### FIELD OF THE DISCLOSURE

The disclosure relates to electric charging systems, and more particularly to techniques for charging multiple vehicles at a charging system equipped with a local energy storage according to an optimized charging scheme.

### BACKGROUND

Charging systems for electric and hybrid-vehicles (EVs) that provide a charging current at least in-part from a battery are inherently limited by the storage capacity of the battery and the availability of an external power source, such as an electric grid, to recharge the battery and/or supply electric energy directly to EVs in the so-called pass-through mode. When the power grid becomes unavailable or is likely to become unavailable in the future with a certain degree of certainty, the charging system may be unable to charge all of the EVs that visit the charging station to the desired level. For example, the charging system may deplete its battery when charging an EV and not be able to provide any charge to another EV that reaches the charging system at a later time, even when the driver of the other EV reserved the use of the charging system in advance.

Still further, even when the electric grid is currently available to a charging station, there may be other reasons for the charging station to prefer to use the battery rather than operate in the pass-through mode, such as for example different rates of charging the station may support in the battery mode and the pass-through mode, or the variable pricing of electricity by an operator of the AC grid.

### SUMMARY

The systems, methods, and computer-readable instructions disclosed herein provide an improved scheme for distributing the electric power at charging stations to service a maximum number of vehicles in a certain interval of time by generating an optimized charging scheme based upon charging optimization factors, and providing charging current to vehicles based upon the optimized charging scheme. As described herein, a vehicle charging system for charging one or more vehicles according to an optimized charging scheme, the vehicle charging system comprising: (i) a power input port configured to receive input electric power from a power source; (ii) a battery configured to receive and store electric power derived from the input electric power received at the power input port; (iii) a vehicle coupling configured to: receive a charging current from one or more of the power source or the battery, and provide an electrical interconnect between the vehicle charging system and a vehicle in order to provide the charging current to the vehicle; (iv) a charging optimization engine stored one or more memories and executable by one or more processors to generate an optimized charging scheme for charging the one or more vehicles, the charging optimization engine being communicatively connected via one or more electronic communication connections to a system controller; and (v) the system controller configured to control charging of the one or more vehicles by the vehicle charging system. The system controller may be configured to cause the vehicle charging system to obtain charging optimization data associated with the vehicle charging system. The charging optimization data may include electrical characteristics of the vehicle charging system, environmental characteristics of the vehicle charging system, and/or scheduling data of the vehicle charging system. Based upon the charging optimization data, the charging system via the charging optimization engine generates an optimized charging scheme. The optimized charging scheme may optimize one or more characteristics of vehicle charging, which may include optimizing the charging current provided to the one or more vehicles (e.g., to provide a fast-charging current to as many vehicles as possible) and/or optimize the number of vehicles to charge (e.g., charging a maximum number of vehicles) when providing the charging current to the one or more vehicles according to the optimized charging scheme.

In some embodiments, the power source may be an alternating current (AC) power source, and the charging current may be direct current (DC). In some such embodiments, the vehicle coupling may further be configured to convert the AC of the AC power source to DC, and provide the DC as the charging current.

With respect to the charging optimization data, the electrical characteristics of the vehicle charging system may indicate a state of the input electrical power (e.g., availability of grid power to charge the battery) and/or the battery (the state of charge of the battery used to provide the charging current). The environmental characteristics of the vehicle charging system may indicate one or more of: an ambient temperature, a humidity, a season, a time of day, a day of a year, or a type of weather, one or more of which may affect the battery's ability to hold and/or provide a charge (e.g., extreme hot or cold weather), the expected number of customer wanting to have their vehicle charged (e.g., inclement weather may reduce expected vehicle traffic at the charging site, holidays associated with travel may increase vehicle traffic at the charging site, etc.). The vehicle charging schedule data may indicate the number of vehicles scheduled to be charged at a charging site, a state of charge of the vehicles scheduled to be charged (e.g., providing an indication of how much charging current the site may be expected to provide), a battery capacity of the vehicles (e.g., also providing insight into the charging current to be provided), or a rate of charge of the vehicles (e.g., whether a vehicle is capable of receiving a fast-charging current). As just described, the charging optimization data may include information which may be used by the charging optimization engine to determine how best to optimize the charging current of a vehicle charging system/site via the optimized charging scheme.

In some embodiments, the charging optimization engine may include a machine learning model trained using training data including historical vehicle charging system data and historical vehicle charging data. The historical vehicle charging system data may indicate historical electrical characteristics and/or historical environmental characteristics of historical vehicle charging systems, such as historical vehicle characteristics, a number of historical vehicles charged, historical vehicle charging schedules, etc.

In some embodiments, the vehicle charging system is further configured to charge a first vehicle according to a first optimized charging scheme, and charge a second vehicle according to a second charging scheme.

In some embodiments, the vehicle charging system further comprises an inter-charger connection communicatively connected to the battery and configured to provide a battery charging current to an additional vehicle charging system and to receive a battery charging input from the additional vehicle charging system via a direct connection with the additional vehicle charging system. In some such embodiments, the system controller is further configured to: obtain the charging optimization data of the additional vehicle charging system, and generate the optimized charging scheme further based upon the charging optimization data of the additional vehicle charging system.

Methods or computer-readable media storing instructions for implementing all or part of the vehicle charging system described above may also be provided in some aspects in order to provide or operate a vehicle charging station. Additional or alternative features described herein below may be included in some aspects.

According to one such aspect, a method for charging one or more vehicles according to an optimized charging scheme, the method comprising: (i) receiving, via a power input port, input electric power from a power source; (ii) receiving and storing, via a battery, electric power derived from the input electric power received at the power input port; (iii) receiving, via a vehicle coupling, a charging current from one or more of the power source or the battery; (iv) obtaining, via one or more processors, charging optimization data of the vehicle charging system including one or more of: electrical characteristics of the vehicle charging system, environmental characteristics of the vehicle charging system, or scheduling data for the vehicle charging system; (v) based upon the charging optimization data, generating, via a charging optimization engine stored one or more memories and executable by the one or more processors, the optimized charging scheme to optimize the charging current provided to the one or more vehicles and/or a number of vehicles to charge; (vi) providing, by the one or more processors, the optimized charging scheme to a system controller configured to control charging of the one or more vehicles via the vehicle coupling; and (v) providing, via the vehicle coupling, the charging current to the one or more vehicles according to the optimized charging scheme.

According to another such aspect, a site charging system for charging one or more vehicles at a vehicle charging site according to an optimized charging scheme, the site charging system comprising: (i) a plurality of vehicle charging systems as described above at the vehicle charging site connected via a direct current DC bus; (ii) a charging optimization engine stored one or more memories and executable by one or more processors to generate an optimized charging scheme for charging the one or more vehicles via the vehicle charging system, the charging optimization engine being communicatively connected via one or more electronic communication connections to one or more of the system controller or a centralized management system; and (iii) the centralized management system communicatively connected to the plurality of vehicle charging systems via the one or more electronic communication connections, the centralized management system comprising the one or more processors configured to: (a) obtain charging optimization data of the vehicle charging site, the charging optimization data including one or more of: electrical characteristics of the vehicle charging site, environmental characteristics of the vehicle charging site, or scheduling data for the vehicle charging site; (b) based upon the charging optimization data of the vehicle charging site, generate an optimized charging scheme to optimize the charging current provided to the one or more vehicles and/or a number of vehicles to charge; and (c) provide the charging current to the one or more vehicles according to the optimized charging scheme.

### BRIEF DESCRIPTION OF THE DRAWINGS

FIG. 1 illustrates a block diagram of an example of a charging site configured for energy management between multiple vehicles charging systems, in accordance with certain aspects disclosed herein.

FIG. 2 illustrates a block diagram of an example of an electric vehicle charging system, in accordance with certain aspects disclosed herein.

FIG. 3 illustrates a block diagram illustrating a simplified example of a hardware implementation of a controller, in accordance with certain aspects disclosed herein.

FIG. 4A illustrates a block diagram of an example computing environment for training a machine learning model, in accordance with certain aspects disclosed herein.

FIG. 4B illustrates a combined block and logic diagram for training a charging optimization machine leaning model to generate an optimized charging scheme, in accordance with certain aspects disclosed herein.

FIG. 5 is a flow diagram of an example method for charging one or more vehicles according to an optimized charging scheme, in accordance with certain aspects disclosed herein.

### DETAILED DESCRIPTION

The techniques disclosed herein generally relate to solving the problem of optimizing power charging stations to provide a charging current to service a maximum number of vehicles. In order to optimize the charging current, a charging optimization engine, which may include a machine learning model, generates an optimized charging scheme for a vehicle charging system/charging site based upon charging optimization data. The charging optimization data may indicate conditions, criteria, factors, circumstances, etc., which can affect the ability of a vehicle charging system to provide a charging current, such as a battery-based fast-charging current. The charging optimization data may include electrical characteristics of the vehicle charging system, environmental characteristics of the vehicle charging system, and/or scheduling data for the vehicle charging system. The optimized charging scheme may optimize the charging current provided to one or more vehicles and/or a number of vehicles to charge. The vehicle charging system may provide the charging current to the vehicles according to the optimized charging scheme.

One challenge that arises from such battery-based charging systems is how to maximize the fast-charging made possible by the source battery providing the charging current in light of the various circumstances which may affect the source battery's state of charge, such as the availability of the grid to recharge the source battery. For example, just a few vehicles having a nearly-depleted batteries and/or large capacity batteries which require charging may receive a battery-based charging current which quickly depletes the source battery, making fast-charging unavailable for subsequent vehicle charging until the source battery is sufficiently recharged, which takes time. When the source battery is sufficiently drained such that it requires charging from an alternate power source such as the grid, the charging system is then at the mercy of the power source and associated recharging time to regain its ability for fast-charging, which may be jeopardized by factors such as black-outs, brown-outs, or prohibitively-high grid electricity rates during peak hours which may coincide with the source battery recharging. Moreover, other factors may affect the ability to provide a fast-charging current from a source-battery, such as environmental factors like cold weather which may slow the chemical reactions taking place within the source battery, reducing its ability to provide an adequate charging current. In addition to these situations causing frustration for the vehicle charging provider wanting to provide reliable charging for its customers, the customers likewise bear the brunt of such charging inadequacies when being unable to charge their vehicle in a timely fashion, if at all, any of which may have an associated effect of detrimentally impacting adoption of electric and charging hybrid vehicles. Therefore, improved techniques for optimizing power at charging stations to provide a charging current which services a maximum number of vehicles is needed.

Several aspects of the electric vehicle or plug-in hybrid vehicle charging system and related charging site systems will now be presented with reference to various embodiments. Although described herein as relating to EVs, it should be understood that the techniques may be applied equally to plug-in hybrid vehicles or other wholly or partially battery-powered devices that may be charged by a high-voltage or high-power charging station. Charging stations are used for recharging batteries in EVs by supplying AC or DC power to EVs. In turn, the charging stations receive an electric power supply from a utility power grid connection or local power source (e.g., solar, wind, water, or hydrocarbon-powered power generation systems). Some charging stations may store power in one or more internal or connected batteries in order to smooth power consumption over time. The charging stations/charging sites may further generate an optimized charging scheme for providing the charging current, thereby optimizing the number of vehicles to charge, the charging current provided to the vehicles, or other suitable optimizations.

### Exemplary Charging Site

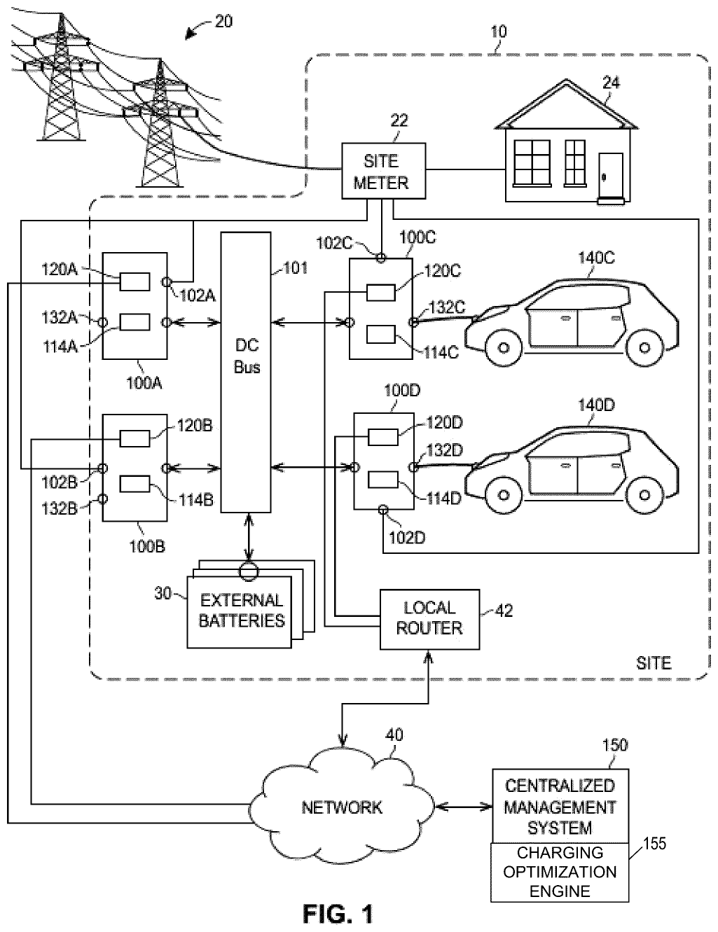

FIG. 1 illustrates a block diagram of an example of a charging site 10 configured to charge vehicles via one or more vehicle charging systems 100A-D according to an optimized charging scheme. The vehicle charging systems 100A-D may charge a vehicle via a DC bus 101.

The charging site 10 may be supplied with AC power from an electric power grid 20 via a site meter 22, which may record power consumption and/or other electrical characteristics of the charging site 10, and connect the various electrical components disposed at the charging site 10 to the electric power grid 20. Thus, the electric power grid 20 may provide AC power to each of the vehicle charging systems 100A-D and other electrical components via the site meter 22, including providing AC power to a non-charging load 24 (e.g., commercial building electrical infrastructure) at the charging site 10. In some embodiments, the site meter 22 is a smart meter including additional control logic and communication functionality. For example, the site meter 22 may be configured to communicate with one or more external servers (not show) and/or the centralized management system 150, e.g., to exchange demand data regarding load on, and/or demand charges for, AC power from the electric power grid 20. In some such embodiments, the site meter 22 may be configured to disconnect part or all of the loads from the electric power grid 20 upon the occurrence of certain conditions (e.g., during peak hours or when the power grid is unstable due to high demand). In this way, the site meter 22 may be used to separate the charging site 10 from the electric power grid 20 when needed. Although only one site meter 22 is shown, some embodiments may include a plurality of meters, each of which may perform part or all of the operation of the site meter 22. Such embodiments may be implemented to facilitate more targeted control of operations of individual vehicle charging systems 100 or non-charging loads 24 at the charging site 10.

The AC power from the site meter 22 may be provided as an input AC electric power to the vehicle charging system 100, for example via the respective input ports 102A-D of the vehicle charging systems 100A-D via one or more wired AC connections. In some embodiments, the input AC electric power is received at each of the input ports 102A-D as a 120V or 240V single-phase or three-phase AC power supply. As discussed elsewhere herein, each of the vehicle charging systems 100A-D converts and stores such input AC electric power to DC power stored in batteries of respective energy storage modules 114A-D, from which charging currents may be provided to vehicles via vehicle electric couplings (or just “couplings”) 132A-D of the vehicle charging systems 100A-D. The vehicle charging systems 100A-D are controlled by respective system controllers 120A-D, which monitor operating data of the respective vehicle charging systems 100A-D and control charging and discharging of the energy storage modules 114A-D.

In some embodiments, the DC power may be stored in the energy storage modules 114A-D over an interval of time in order to provide charging current to EVs via respective vehicle couplings 132A-D at a faster rate than the input AC electric power is received by the vehicle charging systems 100A-D. While this has significant advantages in reducing the electrical infrastructure requirements for the charging site 10, some of the vehicle charging systems 100A-D may be used more than others. For example, vehicle charging systems 100C and 100D may experience greater use due to closer proximity to a destination (e.g., by being located in a parking lot at locations nearer an entrance to a commercial building). As illustrated, vehicles 140C and 140D may be connected to vehicle charging systems 100C and 100D by vehicle couplings 132C and 132D, respectively, in order to receive charging currents from energy stored in the energy storage modules 114C and 114D, while no vehicles are charging at vehicle charging systems 100A and 100B. Thus, the batteries of vehicle charging systems 100C and 100D will discharge faster than those of vehicle charging systems 100A and 100B, resulting in a charge imbalance among the energy storage modules 114A-D. To address such an imbalance, energy may be transferred from vehicle charging systems 100A and 100B to vehicle charging systems 100C and 100D via the DC bus 101.

The DC bus 101 may provide a direct DC power connection between the vehicle charging systems 100A-D to enable charge transfers among the energy storage modules 114A-D. Each of the vehicle charging systems 100A-D includes an inter-charger connection (not shown) that provides a bidirectional DC connection to the DC bus 101, and thereby to each of the other vehicle charging systems 100A-D. Through such inter-charger connections, the vehicle charging systems 100A-D are enabled to receive and to provide DC at various times as part of charge transfers, which may be used to perform charge balancing between the energy storage modules 114A-D. In some embodiments, one or more external batteries 30 are also connected to the DC bus 101 to store energy received from the vehicle charging systems 100A-D and provide the stored energy at a later time, as needed. Such external batteries 30 may include controllers (not shown) to control charging and discharging, or the external batteries 30 may be controlled by the system controllers 120A-D of the vehicle charging systems 100A-D or by a centralized management system 150. Similarly, in various embodiments, charge transfers may be determined and controlled by the system controllers 120A-D of the vehicle charging systems 100A-D or by a centralized management system 150. To facilitate such control decisions, each of the system controllers 120A-D is connected via wired or wireless communication connections with the other system controllers 120A-D and/or with the centralized management system 150 to exchange electronic messages or signals.

The centralized management system 150 may communicate with each of the vehicle charging systems 100A-D in order to monitor operating data regarding the vehicle charging systems 100A-D (e.g., electrical characteristics, environmental characteristics, etc.), schedule vehicle charging, determine and control charge transfers as needed, generate via a charging optimization engine 155 an optimized charging scheme for charging one or more vehicles 140 via the vehicle charging systems 100A-100D, among other things. The centralized management system 150 may be located at the charging site 10 or at a location remote from the charging site 10. When remote from the charging site 10, the centralized management system 150 may be communicatively connected to the charging site 10 and/or vehicle charging systems 100A-D via a network 40, which may be a proprietary network, a secure public internet, a virtual private network, or some other type of network, such as dedicated access lines, plain ordinary telephone lines, satellite links, cellular data networks, or combinations of these. In various embodiments, the vehicle charging systems 100A-D may be communicatively connected with the network 40 directly or via a local router 42. In some embodiments in which the centralized management system 150 is located at the charging site 10, the centralized management system 150 may be combined with or incorporated within any of the vehicle charging systems 100. In still further embodiments, the centralized management system 150 may be configured as a local cloud or server group distributed across the system controllers 120A-D of the vehicle charging systems 100A-D in order to provide robust control in the event of a network disruption.

In some embodiments, the centralized management system 150 may also communicate with remote vehicle charging systems that are deployed in locations remote from the charging site 10, which locations may be separated by large geographic distances. For example, the centralized management system 150 may communicate with vehicle charging systems 100 located in different parking facilities, on different floors of the same parking structure, or in different cities. Such centralized management system 150 may comprise one or more servers configured to receive operating data from, and to send data and/or control commands to, each of the vehicle charging systems 100A-D. To facilitate communication, the centralized management system 150 may be communicatively connected to the system controllers 120A-D of the vehicle charging systems 100A-D via an electronic communication link with a communication interface module (not shown) within each of the vehicle charging systems 100A-D.

The centralized management system 150 may group or relate vehicle charging systems according to their location, their intended function, availability, operating status, and capabilities. The centralized management system 150 may remotely configure and control the vehicle charging systems, including the vehicle charging systems 100A-D. The centralized management system 150 may remotely enforce regulations or requirements governing the operation of the vehicle charging systems 100A-D. The centralized management system 150 may remotely interact with users of the vehicle charging systems 100A-D. The centralized management system 150 may remotely manage billing, maintenance, and error detection for each of the vehicle charging systems 100A-D. For example, error conditions resulting in manual disconnection of a vehicle from any of the vehicle charging systems 100A-D may be reported by such vehicle charging system to the centralized management system 150 for analysis. The centralized management system 150 may also communicate with mobile communication devices of users of the vehicle charging systems 100A-D, such as mobile communication devices or other computing devices used by operators of the vehicle charging systems 100A-D to enable the operator to schedule charging of a vehicle at the charging systems 100, self-configure the vehicle charging systems 100A-D, charge pricing, language localization, currency localization, and so on.

The charging site 10 may include a charging optimization engine 155 which generates one or more optimized charging schemes for charging the one or more vehicles via the charging systems 100A-D. The charging optimization engine 155 may be stored in one or more memories and executable by one or more processors, such as the centralized management system 150, the charging system controller 120, a server (not shown) communicatively connected (e.g., via network 40) to the centralized management system 150 and/or system controller 120, and/or any other suitable memories and/or processors of the charging site 10. The charging optimization engine 155 may generate the optimized charging scheme based upon charging optimization data associated with the charging site 10 and/or the charging systems 100A-100D. The charging optimization engine 155 may be executed at one or more times (e.g., always executing, executing at specific intervals, according to a schedule, etc.) to generate one or more optimized charging schemes for one or more vehicle charging systems 100 and/or sites 10. For example, the charging optimization engine 155 may be run as a background application on a server communicate connected to the vehicle charging systems 100 and/or sites 10 (e.g., via network 40) to continuously receive charging optimization data and provide updated charging optimization schemes in real-time to each vehicle charging system 100 of a charging site 10.

The charging optimization engine 155 may obtain and/or receive (e.g., via the network 40) the charging optimization data from the site meter 22, from the centralized management system 150, from one or more vehicle charging systems 100, from a database, from a server, and/or any other suitable source of charging optimization data. In at least some aspects, one or more of the site meter 22, the centralized management system 150, or the vehicle charging system 100 may include sensors or other components to sense/detect/generate/etc., the charging optimization data. For example, electrical characteristic associated with charging one or more vehicles may be detected by the site meter 22, the centralized management system 150, or the vehicle charging system 100 (e.g., via electrical sensors). These components 22, 150, 100 may also include sensors which detect environmental characteristics of the vehicle charging systems (e.g., temperature sensors). The charging optimization engine 155 may receive (e.g., via the network 40) weather data associated with the vehicle charging system 100 via an API of a weather website communicatively connected to the charging optimization engine 155. The charging optimization engine 155 may receive vehicle scheduling data from the centralized management system 150, etc.

The charging optimization data may include electrical characteristics of the vehicle charging system 100A-D and/or site 10. For example, the electrical characteristics may include whether the AC grid 20 or other source of AC power is available (e.g., due to a power outage); the state of charge of one or more batteries 10, 114 used to provide a charging current, e.g., which may determine whether only the battery 10, 114, the battery 10, 114 and the AC source 20, or only the AC source 20 are available to provide the charging current, or any other suitable electrical characteristics which may affect optimized charging of the vehicles 140.

The charging optimization data may include environmental characteristics of the vehicle charging system 100A-D and/or site 10. For example, the environmental characteristics may include weather conditions (e.g., temperature, humidity, if it is snowing/raining) which may affect the ability for the one or more batteries 10, 114 to hold and/or provide the charging current (e.g., the slowing of a battery discharge in cold weather), which may affect the number of vehicles expected to be charged (e.g., vehicles schedule for charge may not show up during a blizzard, or there may be fewer than expected vehicles during a rain storm), etc. The environmental characteristic may include temporal conditions, such as the time of day (e.g., more vehicles may be charged during the afternoon than in the middle of the night), the day of the week (e.g., more vehicles may be charged on a Saturday than a Wednesday), whether it is a holiday (e.g., travel holidays like Labor Day may result in more vehicle charging than normal), the time of year/season (e.g., more people may travel by car during warmer months than winter months, requiring more frequent charging). The environmental characteristic may include location-based information, such as the location of the vehicle charging system 100 (e.g., vehicle charging systems 100 near the entrance of a charging site 10 may experience more traffic than those located in the back), or the location of the charging site 10 (e.g., the charging site 10 located near a major highway may experience more traffic than one located in a small town). The environmental characteristic may include any other suitable environmental characteristic which may affect optimized charging of one or more vehicles 140.

The charging optimization data may include scheduling data for the vehicle charging system 100A-D and/or site 10, such as the number of vehicles scheduled at a charging system 100 and/or site 10, the types of vehicles scheduled for charging (e.g., heavy duty vehicle having large battery capacity versus an electric scooter with a comparatively smaller battery), the time, date and location od charging, and/or any other suitable scheduling data which may affect optimized charging of one or more 140. For example, the vehicle charging system 100 may allow a user to reserve a charging time at the charger, e.g., via a webpage, software application, mobile application, etc., associated with the charging system and hosted by the centralized management system 150.

Although the charging site 10 is shown to include certain components, the charging site 10 may include additional, fewer, and/or alternate components, and may be configured to perform additional, fewer, or alternate actions, including components/actions described herein. Furthermore, it should be appreciated that additional and/or alternative connections between components shown in FIG. 1 may be implemented. For example, although the charging site 10 is depicted as having four vehicle charging systems 100A-100D remotely controlled by the centralized management system 150 via the network 40, the charging site 10 may have a dozen vehicle charging systems 100A-100D controlled locally by the centralize management system 150 via a wired connection.

### Exemplary Electric Vehicle Charging System

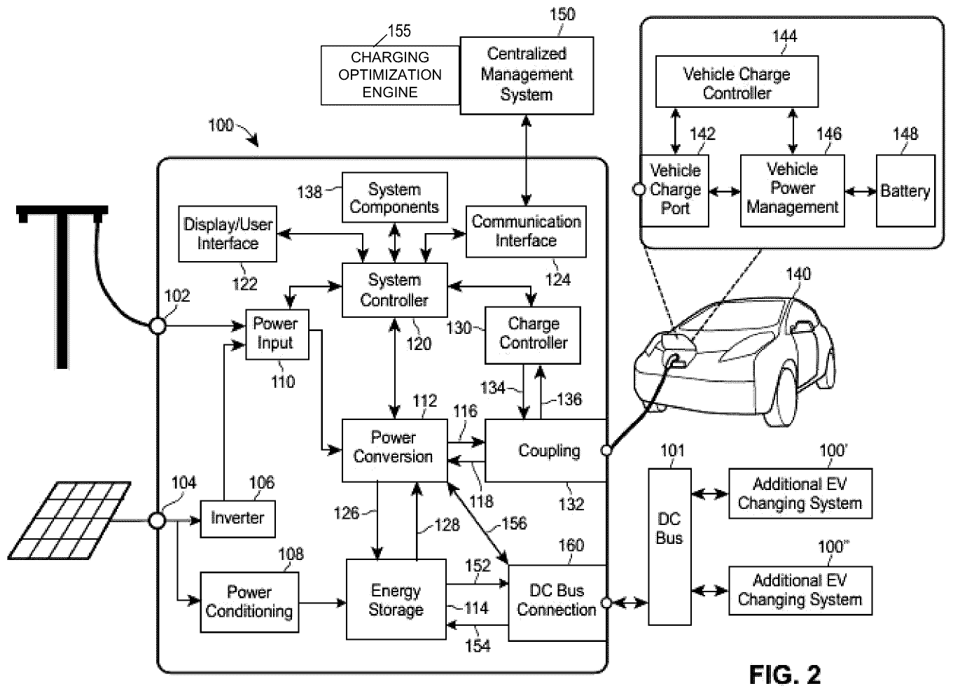

FIG. 2 illustrates a block diagram of an example of a vehicle charging system 100 configured in accordance with certain aspects disclosed herein. The vehicle charging system 100 may be any of the vehicle charging systems 100A-D at the charging site 10 illustrated in FIG. 1. The vehicle charging system 100 may be configured to receive electric power from a power source (e.g., electric power grid 20) via an input port 102 or 104 in order to charge an energy storage module 114 (e.g., one or more batteries), from which the vehicle charging system 100 provides a charging current to a vehicle 140 in order to charge a battery 148 of the vehicle 140. Such charge may be provided through a vehicle coupling 132, which may comprise a charging cable utilizing one or more standard connector types (e.g., Combined Charging System (CCS) or Charge de Move (CHaDEMO) connectors). In addition to being connected to one or more power sources via the input ports 102 or 104, the vehicle charging system 100 may include a DC bus connection 160 to the DC bus 101 at the charging site 10. Through the DC bus connection 160, the vehicle charging system 100 may be configured to send DC power to one or more additional vehicle charging systems 100′ or 100″ and to receive DC power from such additional vehicle charging systems 100′ or 100″, as controlled by a system controller 120 of the vehicle charging system 100. Although the illustrated vehicle charging system 100 is illustrated as communicating with a centralized management system 150, alternative embodiments of the vehicle charging system 100 need not be configured for such external communication. Additional or alternative components and functionality may be included in further alternative embodiments of charging systems.

The vehicle charging system 100 may include a power input module 110 having one or more circuits configurable to transform, condition, or otherwise modify power received from an input port 102 or 104 to provide conditioned power to a power conversion module 112. The input power received at input ports 102 or 104 may be received from an electric power grid 20, a local power generator (e.g., a solar panel or a wind turbine), or any other power source. In some embodiments, input AC power may be received at an AC input port 102, while input DC power may be received at a DC input port 104 (e.g., from photovoltaic cells or other types of DC power sources). The DC input port 104 may be connected to one or more of an inverter module 106 or a power conditioning module 108 for the input DC power. In further embodiments, the DC received via DC input port 104 is converted to AC by an inverter module 106, and the AC is then provided to power input module 110. The power input module 110 may combine AC or DC received from multiple sources. Similarly, the power input module 110 may direct AC or DC received from multiple sources to individual circuits or sections of the power conversion module 112. In some embodiments, the power input module 110 may include a rectifier to convert AC received at an input port 102 or 104 into DC to be provided to the power conversion module 112. In further embodiments, DC received via DC input port 104 may instead be provided to a power conditioning module 108 that may include voltage level converting circuits, filters, and other conditioning circuits to provide a charging current to the energy storage module 114.

The power conversion module 112 includes some combination of one or more AC-to-DC, DC-to-DC, and/or DC-to-AC converters for efficient conversion of AC or DC input power received from a power utility or other source at input port 102 or 104 via the power input module 110 to a DC energy storage current 126 provided to the energy storage module 114, which stores the power until needed to provide a charging current 116 to a vehicle 140. In some embodiments, the power conversion module 112 includes an AC-to-DC conversion circuit that generates a DC energy storage current 126 that is provided to an energy storage module 114. Alternatively, the power input module 110 may include an AC-to-DC conversion circuit to generate a DC from an input AC electric power. In further embodiments, the energy storage module 114 includes high-capacity batteries that have a storage capacity greater than a multiple of the storage capacity in the EVs to be charged (e.g., three times, five times, or ten times an expected vehicle battery capacity). The storage capacity of the energy storage module 114 may be configured based on the optimized charging scheme, for example based upon expected average charge per charging event, which may depend upon factors such as the types of vehicles charged, the depletion level/state of charge of the vehicle batteries when charging starts, the duration of each charging event, and/or any other suitable information which may be used to generate the optimize charging scheme. For example, the charging optimization engine 155 may determine a retail parking site historically has more charging events of shorter duration, while a commuter train parking lot historically has fewer charging events of longer duration, each of which may be considered when generating an optimized charging scheme for each location. In various embodiments, the storage capacity of the energy storage module 114 may be configured based on maximum expected charging offset by power received from an electric utility. In some embodiments, the optimized charging scheme may cause the storage capacity of each of the energy storage modules 114 of the vehicle charging systems 100 and any external batteries 30 at a charging site 10 to be configured to ensure a total charge stored at the charging site 10 is sufficient for an expected maximum load due to vehicle charging. In further embodiments, the power received from an electric utility may be limited to power available during low-demand times, such as off-peak or low-priced periods of the day, with such information being provided to the charging optimization engine 155 when generating the optimized charging scheme. The power input module 110 may be configured to block or disconnect inflows of power during peak or high-priced periods of the day. In some embodiments, the power input module 110 may be configured to enable power reception during peak periods to ensure continued operation of the vehicle charging system 100 when power levels in the energy storage module 114 are unexpectedly low.

In some embodiments, the power conversion module 112 may include one or more DC-to-DC conversion circuits that receive DC 128 at a first voltage level from the energy storage module 114 and drive a charging current 116 to a vehicle 140 through a vehicle coupling 132 to supply a vehicle 140 with the charging current 116 via a vehicle charge port 142.

The vehicle coupling 132 may serve as an electrical interconnect between the vehicle charging system 100 and the vehicle 140. In various embodiments, the vehicle coupling 132 comprises a charging head and/or a charging cable. For example, the vehicle coupling 132 may comprise a charging cable having a standard-compliant plug for connection with a vehicle charge port 142 of vehicles 140. The vehicle coupling 132 may include both a power connection for carrying the charging current 116 and a communication connection for carrying electronic communication between the charge controller 130 and the vehicle 140. In some embodiments, the vehicle charging system 100 may comprise multiple vehicle couplings 132, and the power conversion module 112 may include a corresponding number of DC-to-DC conversion circuits specific to each of the multiple couplings. According to some embodiments, the power conversion module 112 may be further configured to receive a reverse current 118 from a vehicle 140 via the vehicle coupling 132, which reverse current 118 may be used to provide a DC energy storage current 126 to add energy to the energy storage module 114. In some examples, the power conversion module 112 includes one or more inverters that convert the DC 128 to an AC that can be provided as the charging current 116.

A charge controller 130 controls the charging current 116 and/or reverse current 118 through each vehicle coupling 132. To control charging or discharging of the vehicle 140, the charge controller 130 comprises one or more logic circuits (e.g., general or special-purpose processors) configured to execute charging control logic to manage charging sessions with vehicle 140. Thus, the charge controller 130 is configured to communicate with the system controller 120 to control the power conversion module 112 to provide the charging current 116 to the vehicle 140 or to receive the reverse current 118 from the vehicle 140 via the vehicle coupling 132. In some instances, the charge controller 130 may include power control circuits that further modify or control the voltage level of the charging current 116 passed through the vehicle coupling 132 to the vehicle 140. The charge controller 130 also communicates via the vehicle coupling 132 with a vehicle charge controller 144 within the vehicle 140 to manage vehicle charging. Thus, the charge controller 130 communicates with the vehicle charge controller 144 to establish, control, and terminate charging sessions according to EV charging protocols (e.g., CCS or CHaDEMO). The charge controller 130 may be communicatively connected with the vehicle coupling 132 to provide output signals 134 to the vehicle charge controller 144 and to receive input signals 136 from the vehicle charge controller 144.

The system controller 120 may configured to control operations of the vehicle charging system 100, for example based upon an optimized charging scheme executed by the system controller 120, by implementing control logic using one or more general or special-purpose processors. The system controller 120 may be configured to monitor (e.g., via sensors) and control power levels received by the power input module 110, power levels output through the charging current 116, energy levels in the energy storage module 114, and charge received from, or output to, the DC bus 101 via the DC bus connection 160. The system controller may generate charging optimization data (e.g., electrical characteristic data) and provide such data to the charging optimization engine 155. The system controller 120 may be further configured to communicate with, and control each of, the one or more charge controllers 130, as well as controlling the power conversion module 112. For example, the system controller 120 is configured to control the power conversion module 112 and the charge controller to supply a charging current 116 to the vehicle coupling 132 in response to instructions from the charge controller 130, e.g., instructions based upon the optimized charging scheme. As discussed further herein, the system controller 120 is also configured to control (either separately or in coordination with the centralized management system 150) charge transfers to manage energy levels of the vehicle charging system 100 in relation to additional vehicle charging systems 100′ and 100″ at the charging site 10.

The system controller 120 may control charge transfers to provide, and/or receive, DC power via a direct connection with one or more additional vehicle charging systems 100′ or 100″ provided by the DC bus 101, e.g., in accordance with the optimize charging scheme. Thus, the system controller 120 may control receiving DC input from, and providing DC output to, the DC bus 101 via a DC bus connection 160 of the vehicle charging system 100 in order to effect charge transfers at the charging site 10. The DC bus connection 160 may serve as an inter-charger connection of the vehicle charging system 100 and may be configured to connect the vehicle charging system 100 to the DC bus 101 at the charging site 10 as a direct connection for the exchange of DC power between the vehicle charging system 100 and additional vehicle charging systems 100′ and 100″ (e.g., other vehicle charging systems of the vehicle charging systems 100A-D) at the charging site 10, as well as with any external batteries 30 at the site 10 (as illustrated in FIG. 1A). In some embodiments, the DC bus connection 160 receives and provides DC power via a DC link 156 with the power conversion module 112, with the power conversion module 112 being controlled by the system controller 120 to manage any voltage or current requirements of the energy storage module 114 or the DC bus 101. In additional or alternative embodiments, the DC bus connection 160 may directly interface with the energy storage module 114 in order to provide a DC output current 152 from the energy storage module 114 to the DC bus 101 and to provide a DC input current 154 from the DC bus 101 to the energy storage module 114, as controlled by the system controller 120.

The system controller 120 may be configured to communicate with various system components 138 of the vehicle charging system 100 (e.g., other controllers or sensors coupled to the energy storage module 114 or other components of the vehicle charging system 100) to receive charging optimization data, receive operating data (e.g., the charging optimization scheme), control operation of the charging system 100 via operation of such system components 138, etc. For example, the system controller 120 may monitor temperatures within and/or proximate to the vehicle charging system 100 using the system components 138 and may be further configured to provide the associated data to the charging optimization engine 155, e.g., via communication interface 124. The system controller 120 may communicate with a user interface module 122 (e.g., a touchscreen display) and a communication interface module 124 (e.g., a network interface controller) to provide information and receive control commands. Each communication interface module 124 may be configured to send and receive electronic data and/or messages via wired or wireless data connections, which may include portions of one or more digital communication networks such as network 40.

The system controller 120 may be configured to include, execute, and/or be communicatively connect with, the charging optimization engine 155, e.g., for the system controller 120 to operate the charging systems 100A-100D according to the optimized charging scheme generated by the charging optimization engine 155. For example, the system controller 120 may monitor electrical characteristics of the charging system 100A-100D (e.g., state of the AC power source such the grid 20, the state of charge of the energy storage 114), and/or environmental characteristics of the charging system 100A-100D (e.g., ambient temperature), and provide the associated data to the charging optimization engine 155. Based upon the electrical and/or environmental characteristics, among other things, the charging optimization engine 155 may generate the optimized charging scheme for the one or more charging systems 100A-100D, e.g., the amount of charging current to provide to the vehicles 140 (e.g., unlimited versus limited), the rate at which to provide the charging current (e.g., fast-charging versus slower charging), the power sources to provide the charging current (battery and/or AC-based charging current), etc. The system controller 120 may then provide the charging current to the vehicles 140 according to the parameters of the optimized charging scheme.

The system controller 120 may configured to communicate with the components of the vehicle charging system 100, including power input module 110, power conversion module 112, the user interface module 122, the communication interface module 124, the charge controller 130, and the system components 138, over one or more data communication links. The system controller 120 may also be configured to communicate with external devices, including a vehicle 140 via the vehicle coupling 132, one or more additional vehicle charging systems 100′ and 100″ via the centralized management system 150, one or more external batteries 30, or the site meter 22. The system controller 120 may manage, implement or support one or more data communication protocols used to control communication over the various communication links, including wireless communication or communication via a local router 42. The data communication protocols may be defined by industry standards bodies or may be proprietary protocols.

The user interface module 122 may be configured to present information related to the operation of the vehicle charging system 100 to a user and to receive user input. The user interface module 122 may include or be coupled to a display with capabilities that reflect intended use of the vehicle charging system 100. In one example, a touchscreen may be provided to present details of charging status and user instructions, including instructions describing the method of connecting and disconnecting a vehicle 140. The user interface module 122 may include or be coupled to a touchscreen that interacts with the system controller 120 to provide additional information or advertising. The system controller 120 may include or be coupled to a wireless communication interface that can be used to deliver a wide variety of content to users of the vehicle charging system 100, including advertisements, news, point-of-sale content for products/services that can be purchased through the user interface module 122. The display system may be customized to match commercial branding of the operator, to accommodate language options and for other purposes. The user interface module 122 may include or be connected to various input components, including touchscreen displays, physical input mechanisms, identity card readers, touchless credit card readers, and other components that interact through direct connections or wireless communications. The user interface module 122 may further support user authentication protocols and may include or be coupled to biometric input devices such as fingerprint scanners, iris scanners, facial recognition systems and the like.

In some embodiments, the energy storage module 114 is provisioned with a large battery pack. The system controller 120 may use the optimized charging scheme and/or software to manage input received from a power source to the battery pack based upon demand level data (e.g., demand or load data from an electric power grid 20 or site meter 22), such that power is drawn from the power source to charge the battery pack at one or more optimal times, e.g., low-load time periods to avoid drawing power from the grid during peak-load hours. The system controller 120 may be further configured to manage power output to provide full, fast charging power in accordance with the optimized charging scheme, and/or to avoid situations in which the battery pack becomes fully discharged or depleted beyond a minimum energy threshold. For example, the optimized charging scheme may cause the system controller 120 to provide limited vehicle charging current at a first time based upon a predicted later demand at a second time, e.g., based upon charging schedule data and the state of charge of the battery pack. The optimized charging scheme may spread limited charging capacity more evenly among vehicles 140 throughout the course of a day, allowing for the charging of an increased number of vehicles 140 as compared to the system controller operating without the optimized charging scheme.

In further embodiments, the system controller 120 may execute the optimized charging scheme and/or the charging optimization engine 155 (either separately or in coordination with the centralized management system 150) to manage energy draw and use, by controlling charging and discharging over time among multiple vehicle charging systems 100 at the charging site 10. Thus, the charge drawn from the power source may be limited or avoided during peak-load hours by charge transfer between the vehicle charging system 100 and one or more additional vehicle charging systems 100′ and 100″ via the DC bus 101 at the charging site 10, effectively pooling the energy stored in the batteries of all of the charging systems at the charging site 10. As noted above, in some embodiments, the charging site 10 may include one or more external batteries 30 connected to the DC bus 101. In such embodiments, the systems controller 120 and/or the centralized management system 150 may further manage energy inflow and outflow at the charging site 10 by controlling selective charging and discharging such batteries at appropriate time periods to avoid or reduce total power draw of the charging site 10 from the power source during peak-demand or other high-demand times by charging the batteries of the vehicle charging systems 100 and the external batteries 30 during low-demand times, e.g., according to the optimized charging scheme. In some such embodiments, such energy management enables the vehicle charging system 100 to continue charging vehicles 140, e.g., according to the optimized charging scheme generated by the charging optimization engine 155, even when the power source is disconnected or unavailable (e.g., when a local power grid 20 is down). The system controllers 120 of the vehicle charging systems 100 and/or the centralized management system 150 may further manage site-wide energy use by controlling charge transfers, e.g., based upon the optimized charging scheme, differential charge levels or discharge levels associated with differential utilization of the various vehicle charging system 100 at the charging site 10 in order to effect charge balancing or to ensure sufficient charge availability for charging vehicle 140 at one or more of the vehicle charging systems 100.

In some embodiments, the vehicle charging system 100 may be configured with two or more vehicle couplings 132 to enable concurrent charging of multiple vehicles 140 according to the optimized charging scheme. The system controller 120 may be configured by a user via the user interface module 122 to support multiple modes of operation and may define procedures for charge transfer or power distribution that preserves energy levels in the energy storage module 114 when multiple vehicles 140 are being concurrently charged. Charge transfers may be used to transfer power from vehicle charging systems 100 that have available power or are not being used to charge a vehicle 140 to vehicle charging systems 100 that are charging one or more vehicles 140. The optimized charging scheme may provide for a distribution of power to enable fast charging of one or more vehicles 140 at the expense of other vehicles 140. In this regard, the vehicle couplings 132 may be prioritized or the system controller 120 may be capable of identifying and prioritizing connected vehicles 140. In some instances, the system controller 120 may be configured to automatically control the respective charge controllers 130 to split available power between two vehicles 140 after the second vehicle 140 is connected. The available power may be evenly split between two vehicles 140, split according to priorities and/or capabilities, split according to the optimized charging scheme, etc. In some examples, the system controller 120 may conduct arbitration or negotiation between connected vehicles 140 to determine a split of charging capacity, e.g., maximum charge rate, minimum charging time, etc., according to the optimized charging scheme.

As illustrated, a vehicle 140 may be charged by connecting the vehicle 140 to the vehicle charging system 100 via a vehicle coupling 132. This may include plugging a charging cable of the vehicle charging system 100 into a vehicle charge port 142 of the vehicle 140. The vehicle charge port 142 may be configured to receive the charging current 116 through the vehicle coupling 132 and provide such received current to a vehicle power management module 146. The vehicle charge port 142 is further configured to provide an electronic communication connection between the vehicle coupling 132 and a vehicle charge controller 144, which controls charging of the vehicle 140. The vehicle power management module 146 is controlled by the vehicle charge controller 144 to provide power to each of one or more batteries 148 of the vehicle 140 in order to charge such battery 148. In some instances, the vehicle charge port 142 includes a locking mechanism to engage and retain a portion of the vehicle coupling 132 in place during charging sessions. For example, for safety reasons, the vehicle charge controller 144 may control a locking mechanism of the vehicle charge port 142 to lock a plug of a charging cable in the vehicle charge port 142 while a charging session is active.

As previously described with respect to FIG. 1, although the vehicle charging system 100 is shown to include certain components, the vehicle charging system 100 may include additional, fewer, and/or alternate components, and may be configured to perform additional, fewer, or alternate actions, including components/actions described herein. Furthermore, it should be appreciated that additional and/or alternative connections between components shown in FIG. 2 may be implemented.

### Exemplary Controller

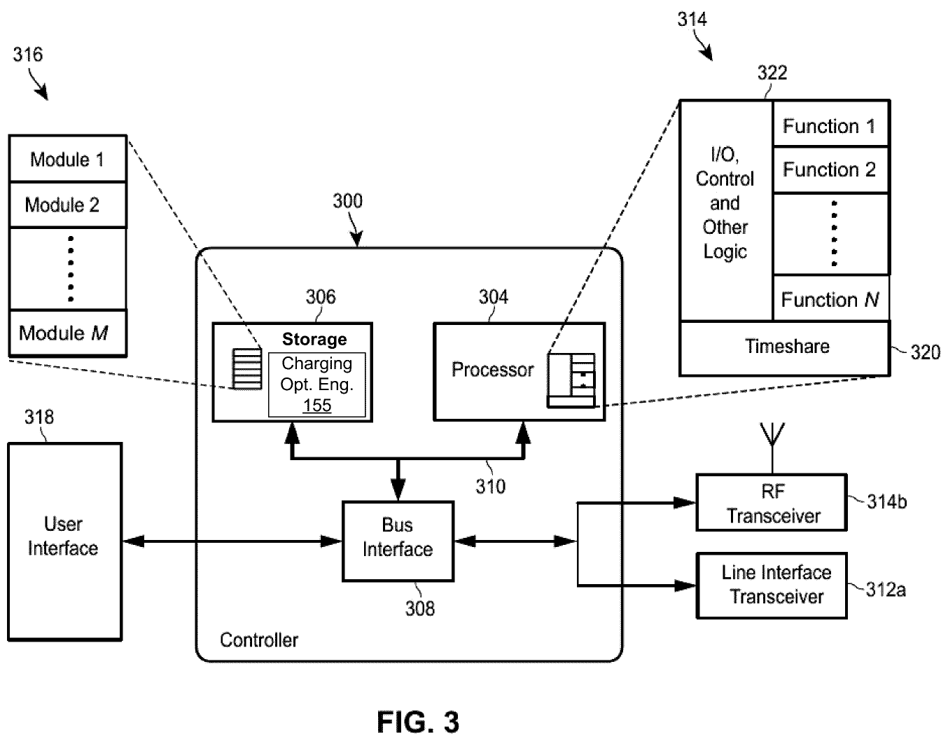

FIG. 3 illustrates a block diagram illustrating a simplified example of a hardware implementation of a controller 300, such as any of the system controller 120, the charge controller 130, the vehicle charge controller 144, and/or the centralized management system 150 disclosed herein. In some embodiments, the controller 300 may be a controller of a site meter 22, an external battery 30, an external battery system 230, and/or any other component disclosed herein that implements control logic to control any aspect of the described systems and methods. The controller 300 may include one or more processors 304 that are controlled by some combination of hardware and software modules. Examples of processors 304 include microprocessors, microcontrollers, digital signal processors (DSPs), application-specific integrated circuits (ASICs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 304 may include specialized processors that perform specific functions, which may be configured by one or more of the software modules 316. The one or more processors 304 may be configured through a combination of software modules 316 loaded during initialization and may be further configured by loading or unloading one or more software modules 316 during operation.

In the illustrated example, the controller 300 may be implemented with a bus architecture, represented generally by the bus 310. The bus 310 may include any number of interconnecting buses and bridges depending on the specific application of the controller 300 and the overall design constraints. The bus 310 links together various circuits including the one or more processors 304 and storage 306. Storage 306 may include memory devices and mass storage devices, any of which may be referred to herein as computer-readable media. The bus 310 may also link various other circuits, such as timing sources, timers, peripherals, voltage regulators, and power management circuits. A bus interface 308 may provide an interface between the bus 310 and one or more line interface circuits 312, which may include a line interface transceiver circuit 312A and a radio frequency (RF) transceiver circuit 312B. A line interface transceiver circuit 312A may be provided for each networking technology supported by the controller. In some instances, multiple networking technologies may share some or all of the circuitry or processing modules found in a line interface circuit 312, such as line interface transceiver circuit 312A for wired communication and RF transceiver circuit 312B for wireless communication. Each line interface circuit 312 provides a means for communicating with various other devices over a transmission medium. In some embodiments, a user interface 318 (e.g., touchscreen display, keypad, speaker, or microphone) may also be provided, and may be communicatively coupled to the bus 310 directly or through the bus interface 308.

A processor 304 may be responsible for managing the bus 310 and for general processing that may include the execution of software stored in a computer-readable medium that may include the storage 306. In this respect, the processor 304 of the controller 300 may be used to implement any of the methods, functions, and techniques disclosed herein. The storage 306 may be used for storing data that is manipulated by the processor 304 when executing software, and the software may be configured to implement any of the methods disclosed herein.

One or more processors 304 in the controller 300 may execute software, such as the charging optimization engine 155. Software may include instructions, instruction sets, code, code segments, program code, programs, subprograms, software modules, applications, software applications, software packages, models, routines, subroutines, objects, executables, threads of execution, procedures, functions, algorithms, etc., whether referred to as software, firmware, middleware, microcode, hardware description language, or otherwise. The software may reside in computer-readable form in the storage 306 or in an external computer readable medium. The external computer-readable medium and/or storage 306 may include a non-transitory computer-readable medium. A non-transitory computer-readable medium includes, by way of example, a magnetic storage device (e.g., hard disk, floppy disk, magnetic strip), an optical disk, a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. Portions of the computer-readable medium or the storage 306 may reside in the controller 300 or external to the controller 300 (e.g., such as a database accessible via network 40). The computer-readable medium and/or storage 306 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 306 may maintain software maintained or organized in loadable code segments, modules, applications, programs, etc., which may be referred to herein as software modules 316. Each of the software modules 316 may include instructions and data that, when installed or loaded on the controller 300 and executed by the one or more processors 304, contribute to a run-time image 314 that controls the operation of the one or more processors 304. When executed, certain instructions may cause the controller 300 to perform functions in accordance with certain methods, algorithms, models (e.g., machine learning models), optimized charging schemes, and processes described herein.

Some of the software modules 316 may be loaded during initialization of the controller 300, and these software modules 316 may configure the controller 300 to enable performance of the various functions disclosed herein. For example, some software modules 316 may configure internal devices or logic circuits 322 of the processor 304, and may manage access to external devices such as line interface circuits 312, the bus interface 308, the user interface 318, timers, mathematical coprocessors, etc. The software modules 316 may include a control program or an operating system that interacts with interrupt handlers and device drivers to control access to various resources provided by the controller 300. The resources may include memory, processing time, access to the line interface circuits 312, the user interface 318, etc.

One or more processors 304 of the controller 300 may be multifunctional, whereby some of the software modules 316 are loaded and configured to perform different functions or different instances of the same function. For example, the one or more processors 304 may additionally be adapted to manage background tasks initiated in response to inputs from the user interface 318, the line interface circuits 312, and device drivers. To support the performance of multiple functions, the one or more processors 304 may be configured to provide a multitasking environment, whereby each of a plurality of functions is implemented as a set of tasks serviced by the one or more processors 304 as needed or desired. In one example, the multitasking environment may be implemented using a timesharing program 320 that passes control of a processor 304 between different tasks, whereby each task returns control of the one or more processors 304 to the timesharing program 320 upon completion of any outstanding operations or in response to an input such as an interrupt. When a task has control of the one or more processors 304, the processing circuit is effectively specialized for the purposes addressed by the function associated with the controlling task. The timesharing program 320 may include an operating system, a main loop that transfers control on a round-robin basis, a function that allocates control of the one or more processors 304 in accordance with a prioritization of the functions, or an interrupt-driven main loop that responds to external events by providing control of the one or more processors 304 to a handling function.

In at least some embodiments, the controller 300 may include the charging optimization engine 155 stored as processor executable-instructions in the storage 306. The controller 300 may execute the charging optimization engine 155 via the processor 304 to generate one or more optimized charging schemes used to provide the charging current to charge one or more vehicles, such as vehicles 140, based upon charging optimization data.

As previously described with respect to FIGS. 1 and 2, although the controller 300 is shown to include certain components, the controller 300 may include additional, fewer, and/or alternate components, and may be configured to perform additional, fewer, or alternate actions, including components/actions described herein. Furthermore, it should be appreciated that additional and/or alternative connections between components shown in FIG. 3 may be implemented.

### Exemplary Environment for Machine Learning Model Training

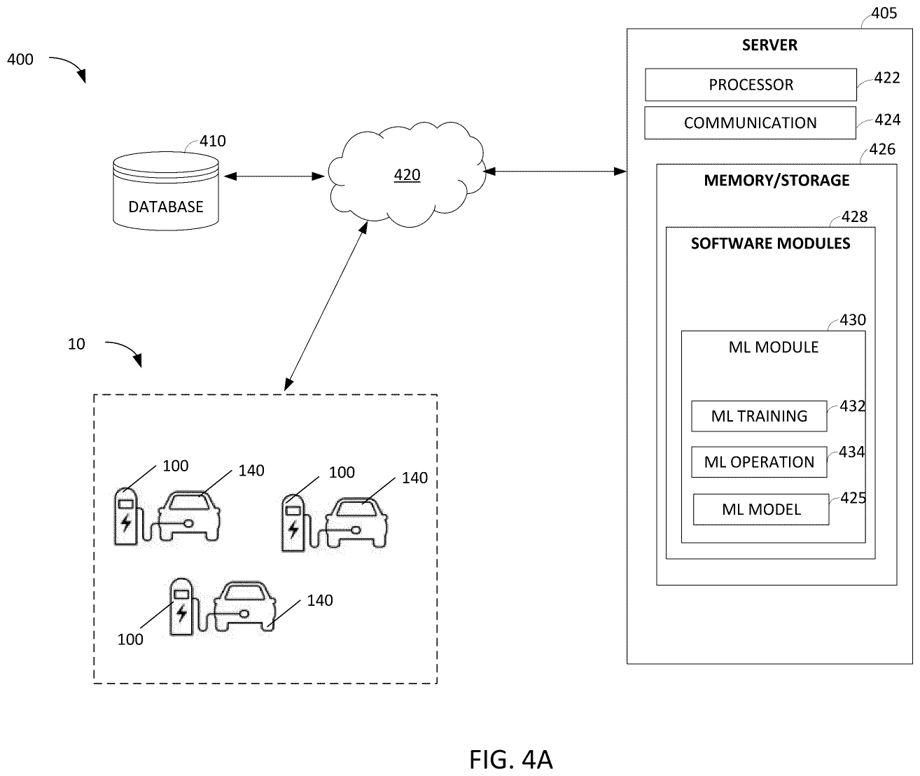

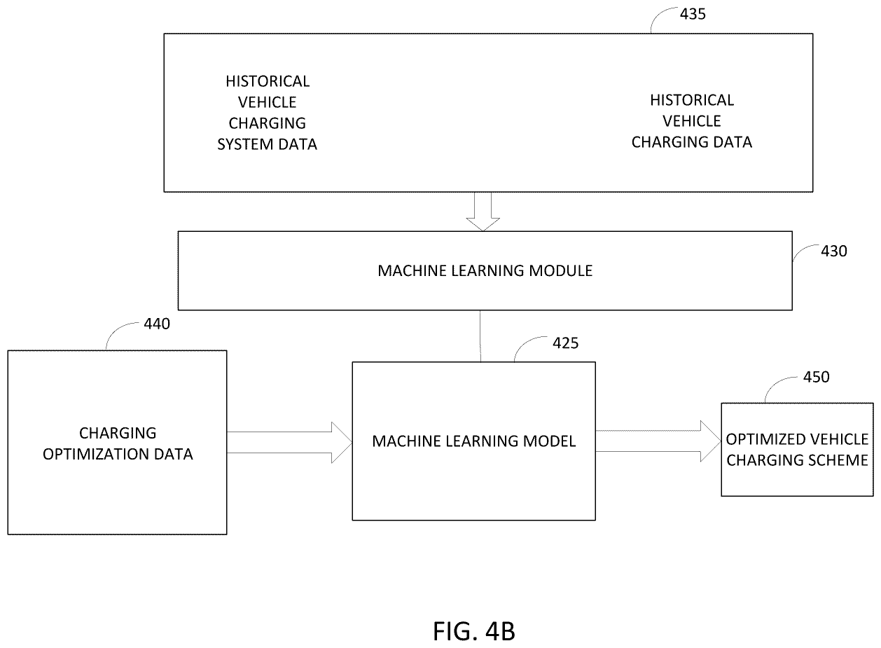

FIG. 4A depicts an exemplary computing environment 400 for training a machine learning model. Although FIG. 4A depicts certain entities, components, equipment, and/or devices, it should be appreciated that additional or alternate entities, components, equipment, and/or devices are envisioned.

As illustrated in FIG. 4A, the computing environment 400 may include, in one aspect, at least one server 405 (e.g., centralized management system 150) which may perform the at least some of the functionalities and techniques disclosed, such as generating an optimized charging scheme. The server 405 may be part of a cloud network or may otherwise communicate with other hardware or software components within one or more cloud computing environments to send, retrieve, or otherwise analyze data or information described herein. In certain aspects of the present techniques, the computing environment 400 may comprise an on-premise computing environment, a multi-cloud computing environment, a public cloud computing environment, a private cloud computing environment, and/or a hybrid cloud computing environment. In one example, an entity (e.g., a business operating vehicle charging sites 10) may host one or more services in a public cloud computing environment (e.g., Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (IaaS) and/or platform-as-a-service (PaaS).

The server 405 may include one or more processors 422, a communication interface module 424, one or more memories 426, and software module 428, such as the previously-described network 40, processor 304, communication interface module 124, the storage 306, software module 316.

The server 405 may include, and/or have access to (e.g., via network 420) one or more databases 410. The databases 410 may be or include a relational database, such as Oracle, DB2, MySQL, a NoSQL based database, such as MongoDB, or another suitable database. The databases 410 may store data and/or datasets, training data used to train and/or operate one or more models (e.g., a machine learning model to generate optimized charging schemes), among other things. A dataset may include one or more types of data, records, files, etc., however, the term data and dataset may be used interchangeably herein.

The computing environment 400 may include a network 420 such as network 40, communicatively connecting one or more components of the computing environment 400.

The software modules 428 may include a machine learning (ML) module 430 to train and/or operate one or more ML models 425. The ML module 430 may include ML training module (MLTM) 432 and/or ML operation module (MLOM) 434. In some embodiments, at least one of a plurality of ML methods and algorithms may be applied by the ML module 430, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 405. For example, libraries may include the TensorFlow based library, the PyTorch library, and/or the scikit-learn Python library.

In one embodiment, the ML module 430 employs supervised learning, which involves identifying patterns in existing data to make predictions about subsequently received data. Specifically, the ML module is “trained” (e.g., via MLTM 432) using training data, which includes exemplary inputs and associated exemplary outputs. Based upon the training data, the ML module 430 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 430 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 430 may organize unlabeled data according to a relationship determined by at least one ML method/algorithm employed by the ML module 430. Unorganized data may include any combination of data inputs and/or ML outputs as described above.

In yet another embodiment, the ML module 430 may employ reinforcement learning, which involves optimizing outputs based upon feedback from a reward signal. Specifically, the ML module 430 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 432 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 434 may comprise a set of computer-executable instructions implementing ML loading, configuration, initialization and/or operation functionality. The MLOM 434 may include instructions for storing trained ML models 425 (e.g., in the electronic databases 410 and/or in memory 426). As discussed, once trained, the one or more trained ML models 425 may be operated in inference mode, whereupon when provided with de novo input that the model has not previously been provided, the model may output one or more predictions, classifications, etc., as described herein.

In operation, ML model training module 432 may access databases 410 or any other data source for training data suitable to generate one or more ML models 425. The training data may be sample data with assigned relevant and comprehensive labels (classes or tags) used to fit the parameters (weights) of an ML model 425 with the goal of training it by example. In one aspect, once an appropriate ML model 425 is trained and validated to provide accurate predictions and/or responses, the trained ML model 425 may be loaded into MLOM 434 at runtime to process input data and generate output data.

In at least some aspects, the trained ML model 425 may be executed on a device other than the server 405. For example, the ML model 425 may reside on the storage 306 of the system controller 300 of the vehicle charging system 100. The processor 304 may execute the ML model 425 to generate the optimized charging scheme to charge vehicles 140. In at least some aspects, the trained server 405 may execute ML model 425, and receive input(s) 440 from, and provide output(s) 450, one or more devices communicatively coupled to the server 405, such as one or more vehicle charging sites 10, vehicle charging systems 100, etc.

While various embodiments, examples, and/or aspects disclosed herein may include training and generating one or more ML models 425 for the server 405 to load at runtime, it is also contemplated that one or more appropriately trained ML models 425 may already exist (e.g., in databases 410) such that the server 405 may load an existing trained ML model 425 at runtime. It is further contemplated that the server 405 may retrain, fine-tune, update and/or otherwise alter an existing ML model 425 before and/or after loading the model at runtime.

### Exemplary Charging Optimization Model Training

FIG. 4B schematically illustrates how to train a charging optimization machine leaning model, such as an ML model of the charging optimization engine 155, to generate an optimized charging scheme to charge one or more vehicles, such as charging vehicle 140 via the vehicle charging system 100 as previously described.

The ML module 430 may include one or more hardware and/or software components (e.g., the MLTM 432 and/or the MLOM 434) to obtain, create, (re)train, operate, fine-tune, and/or store one or more ML models, such as the ML model 425. To train the ML model 425, the ML module 430 may use a training data 435. The server 405 may obtain and/or have available one or more types of training data 435 (e.g., training data 435 stored in databases 410). In one aspect, at least some of the training data 435 may be labeled to aid in (re)training and/or fine-tuning the ML model 425.

In at least some aspects, to train the ML model 425 to generate the optimized charging scheme to charge one or more vehicles, the training data 435 may include historical data indicating historical vehicle charging system data and/or historical vehicle charging data. The historical vehicle charging system data may indicate historical electrical characteristics and/or historical environmental characteristics of the historical vehicle charging systems. For example, the historical vehicle charging system data may indicate historical characteristics such as the state of the input electrical power (e.g., online, offline), the state of the battery (e.g., the state of charge), the amount and/or rate of charge provided to historical vehicles (e.g., as much charge as the vehicle requires, limited charge, faster charging using the battery as a charging source, slower charging using pass-through AC as the charging source), the ambient temperature, the humidity, the season, the time of day, the day of the year, the type of weather, and/or any other suitable training data 435 associated with historical vehicle charging systems.

The training data 435 may include historical vehicle charging data, which may indicate for historical charged vehicles the vehicle characteristics (e.g., the vehicle battery capacity, the vehicle battery state of charge before and after charging, etc.), the number of vehicles charged, the vehicle charging schedules, and/or any other suitable training data 435 associated with historical charged vehicles.

The ML model 425 may be configured to process the training data 435 to learn associations and relationships in the training data 435, e.g., relationships between the historical vehicle charging system data and the historical vehicle charging data which indicate how to optimize vehicle charging. For example, based upon the training data 435, the ML model may learn that certain holidays like Memorial Day have historically resulted an increased number of vehicles to charge, and on such holidays charging stations should operate according to an optimized charging scheme which takes into account the influx of expected vehicle traffic, and accordingly limits the amount of charge the charging system provides to each vehicle on memorial Day as opposed to other holidays like President's Day.

In one aspect, the server 405, ML module 430, and/or other suitable component may continuously update the training data 435, e.g., to include new data associated with optimized vehicle charging. For example, when the trained ML model 425 generates the optimized vehicle charging scheme, various types of data may be associated with the determination which the server 405, ML module 430, etc., may store (e.g., in database 410) as updated training data 435. This may include the charging optimization data the ML model 425 uses as an input to generate the optimized vehicle charging scheme, whether the optimized charging scheme resulted in optimized charging (e.g., based upon the number of vehicles serviced, whether one or more vehicle charging systems ran out of charging current, etc.). Subsequently, the ML model 425 may be retrained based upon the updated training data 435, which may further cause the ML model 425 to improve over time, for example by generating charging schemes with increased optimization.

In one aspect, the ML module 430 may process and/or analyze the training data 435 (e.g., via MLTM 434) to train the ML model 425 to generate the optimized vehicle charging scheme. The ML model 425 may be trained via regression, k-nearest neighbor, support vector regression, and/or random forest algorithms and/or models, although any type of applicable ML algorithm and/or model may be used, including training using one or more of supervised learning, unsupervised learning, semi-supervised learning, and/or reinforcement learning.

Once trained, the ML model 425 may perform operations on one or more data inputs 440 to produce a desired data output 450. In one aspect, the ML model 425 may be loaded at runtime from a database (e.g., by ML module 430 from the databases 410 to process the input data 440. The server 405 and/or ML module 430 may obtain the input data 440 (e.g., from the databases 132), and provide the input data 440 to the trained ML model 425 as an input for the ML model 425 to generate the optimized vehicle charging scheme as an output 450. For example, to generate the optimized vehicle charging scheme as an output 450, the input data 440 may include the charging optimization data, as previously described. The trained ML model 425 may make associations between the charging optimization data, e.g., between the electrical characteristics of the vehicle charging system, the environmental characteristics of the vehicle charging system, and/or scheduling data for the vehicle charging system as indicated by the charging optimization data, to generate the optimized charging scheme as the output 450.

For example, the training data 435 may include historical vehicle charging system data and historical vehicle charging data for numerous vehicle charging systems which have charged thousands of vehicles. The training data 435 may indicate various types of associations which are useful when generating the optimized charging scheme. In one example, during the winter and summer months when extreme temperatures may affect the ability of a battery to hold and/or provide a charge, the temperature will be a more important factor in generating the optimized charging scheme than in fall and spring months. In one example, vehicle charging stations located at rest stops with weight stations historically receive, more traffic from heavy-duty commercial electric vehicle which have much larger batteries than passenger vehicles, indicating that rest stop charging stations having 30 vehicles to charge (e.g., which may likely be commercial vehicles) may require a substantially higher amount of charge to provide than a rest stop in a small town having 30 vehicles to charge (e.g., which may likely be passenger vehicles). These types of associations in the training data may affect the parameters of the optimized charging scheme generated by the charging optimization engine 155.

The trained ML model 425 may be able to receive as inputs 440 charging optimization data and generate as an output 450 the optimized charging scheme. For example, the charging optimization data may indicate electrical characteristics, environmental characteristics, and/or scheduling data of a first charging system, including that the AC grid is presently available to provide a charging current to the charging system batteries and/or vehicles, all vehicle charging system battery is half charged, and the temperature is just above freezing which may slow down/affect the rate of charge provided by the charging system. Based upon this data, the ML model 425 may generate an optimized charging scheme which provides a charging current from both the AC grid and the battery so that the battery is not the only source of charging current, and may further recharge due to the use of the AC current. Additionally, being that the weather would slow a battery-based fast charging current, there may be no detrimental effects to the charging customer of using the AC and battery charging. This charging scheme may be considered optimal as it would allow the battery to charge, the use of the AC as part of the charging current does not deplete the battery as fast as providing a battery-based charging current would, and more vehicles can be charged using the optimized charging scheme than one using a battery-based charging current (e.g., which may fully deplete the battery versus the battery/AC hybrid charging current) or one using purely an AC-based current (e.g., which may provide too slow a charging current which extends charging time for each vehicle versus the hybrid charging current). If the charging optimization data substantially changes, the ML model 425 may generate a new optimized charging scheme. In one example, if the AC grid becomes unavailable, the new optimized charging scheme may provide a battery-based charging current which is restricted to providing a lesser amount of charge than if the AC grid was online. In one example, the temperature rises more than 30 degrees, the new optimized charging scheme may provide a battery-based charging current as the temperature may no longer affect the rate of charge. In one example, if the battery depletes below a 15% state of charge, the new optimized charging scheme may provide an AC-based charging current, and if the battery charges to a 75% state of charge or above, the new optimized charging scheme may provide a battery-based charging current.

The ML model 425 may generate the optimized charging scheme at one or more times throughout the day (e.g., based upon a substantial change in the charging optimization data, a schedule, etc.) using updated input data 440 for each new optimized charging scheme generated as an output 450.

### Exemplary Method for Optimized Charging of Vehicles

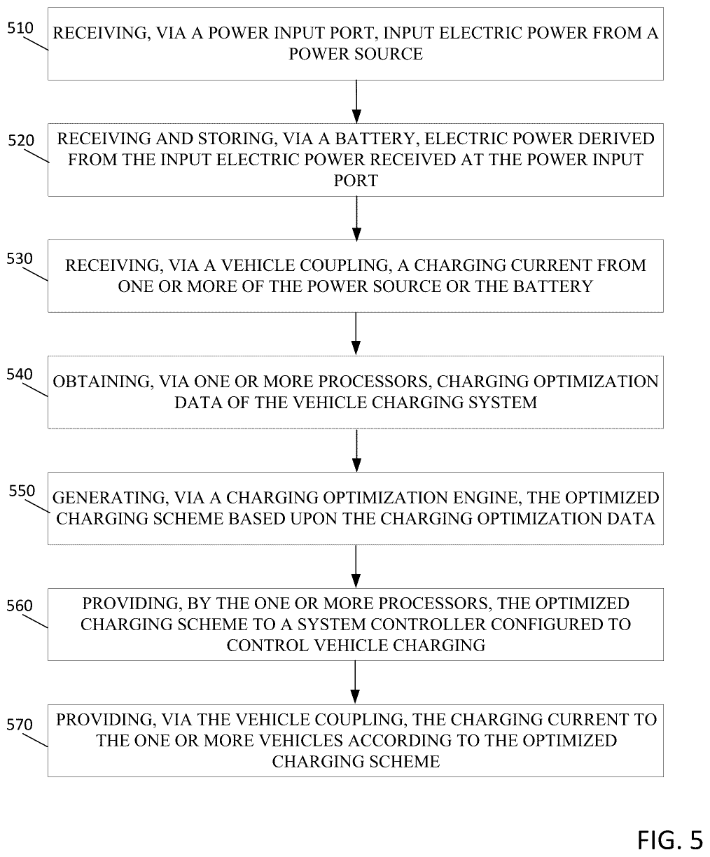

FIG. 5 depicts a flow diagram of an exemplary computer-implemented method 500 for charging one or more vehicles according to an optimized charging scheme. One or more steps of the method 500 may be implemented as a set of instructions stored on a computer-readable memory and executable on one or more processors. The method 500 of FIG. 5 may be implemented via one or more local or remote processors such as processor 304, 422, servers such as server 405, systems such as charging site 10 and/or vehicle charging system 100, and/or other electronic or electrical components, which may be in wired or wireless communication with one another.

The method 500 may include receiving, via a power input port, input electric power from a power source (block 510). The power source may be an AC power source.

The method 500 may include receiving and storing, via a battery, electric power derived from the input electric power received at the power input port (block 520).

The method 500 may include receiving, via a vehicle coupling, a charging current from one or more of the power source or the battery (block 530). The charging current may be DC.

The method 500 may include obtaining, via one or more processors, charging optimization data of the vehicle charging system (block 540). The charging optimization data may include one or more of: electrical characteristics of the vehicle charging system, environmental characteristics of the vehicle charging system, or scheduling data for the vehicle charging system. The electrical characteristics of the vehicle charging system may indicate a state of the input electrical power and/or the battery. The environmental characteristics of the vehicle charging system may indicate one or more of an ambient temperature, a humidity, a season, a time of day, a day of a year, or a type of weather. The vehicle charging schedule data may indicate for the vehicles of the vehicle charging schedule one or more of: the number of vehicles, a state of charge of the vehicles, a battery capacity of the vehicles, or a rate of charge of the vehicles.

The method 500 may include generating, via a charging optimization engine stored one or more memories and executable by the one or more processors, the optimized charging scheme based upon the charging optimization data (block 550). The optimized charging scheme may optimize the charging current provided to the one or more vehicles and/or a number of vehicles to charge;

The method 500 may include providing, by the one or more processors, the optimized charging scheme to a system controller configured to control charging of the one or more vehicles via the vehicle coupling (block 560).

The method 500 may include providing, via the vehicle coupling, the charging current to the one or more vehicles according to the optimized charging scheme (block 570).

In at least some aspects, the method 500 may include converting, via the vehicle coupling, the AC of the AC power source to DC, and providing, via the vehicle coupling, the DC as the charging current.

In at least some aspects of the method 500, the charging optimization engine may include a machine learning model trained using training data including historical vehicle charging system data and historical vehicle charging data. The historical vehicle charging system data may indicate one or more of historical electrical characteristics or historical environmental characteristics of the vehicle charging system. The historical vehicle charging data may indicate one or more of historical vehicle characteristics, a number of historical vehicles charged, or historical vehicle charging schedules.

In at least some aspects, the method 500 may include charging a first vehicle of the one or more vehicles according to a first optimized charging scheme, and charging a second vehicle of the one or more vehicles according to a second charging scheme.

In at least some aspects, the method 500 may include obtaining, via the one or more processors, the charging optimization data of an additional vehicle charging system, wherein (i) an inter-charger connection is communicatively connected to the battery and configured to provide a battery charging current to the additional vehicle charging system and to receive a battery charging input from the additional vehicle charging system via a direct connection with the additional vehicle charging system; and (ii) generating, via the charging optimization engine, the optimized charging scheme is further based upon the charging optimization data of the additional vehicle charging system.

It should be understood that not all blocks of the exemplary flow diagram 500 are required to be performed.

The following list of examples reflects a variety of the embodiments explicitly contemplated by the present disclosure.
Example 1. A vehicle charging system for charging one or more vehicles according to an optimized charging scheme, the vehicle charging system comprising: a power input port configured to receive input electric power from a power source; a battery configured to receive and store electric power derived from the input electric power received at the power input port; a vehicle coupling configured to: receive a charging current from one or more of the power source or the battery; and provide an electrical interconnect between the vehicle charging system and a vehicle in order to provide the charging current to the vehicle; a charging optimization engine stored one or more memories and executable by one or more processors to generate an optimized charging scheme for charging the one or more vehicles, the charging optimization engine being communicatively connected via one or more electronic communication connections to a system controller; and the system controller configured to control charging of the one or more vehicles by the vehicle charging system, and configured to cause the vehicle charging system to: obtain charging optimization data of the vehicle charging system including one or more of: electrical characteristics of the vehicle charging system, environmental characteristics of the vehicle charging system, or scheduling data for the vehicle charging system; based upon the charging optimization data, generate an optimized charging scheme to optimize the charging current provided to the one or more vehicles and/or a number of vehicles to charge; and provide the charging current to the one or more vehicles according to the optimized charging scheme.
Example 2. The vehicle charging system of example 1, wherein: the power source is an alternating current (AC) power source; and the vehicle coupling is further configured to convert the AC of the AC power source to direct current (DC), and provide the DC as the charging current.
Example 3. The vehicle charging system of example 1, wherein the charging current is DC.
Example 4. The vehicle charging system of example 1, wherein the electrical characteristics of the vehicle charging system indicate a state of the input electrical power and/or the battery.
Example 5. The vehicle charging system of example 1, wherein the environmental characteristics of the vehicle charging system indicate one or more of: an ambient temperature, a humidity, a season, a time of day, a day of a year, or a type of weather.
Example 6. The vehicle charging system of example 1, wherein the vehicle charging schedule data indicates for the vehicles of the vehicle charging schedule one or more of: the number of vehicles, a state of charge of the vehicles, a battery capacity of the vehicles, or a rate of charge of the vehicles.
Example 7. The vehicle charging system of example 1, wherein the charging optimization engine includes a machine learning model trained using training data including historical vehicle charging system data and historical vehicle charging data.
Example 8. The vehicle charging system of example 7, wherein the historical vehicle charging system data indicates one or more of historical electrical characteristics or historical environmental characteristics of the vehicle charging system.
Example 9. The vehicle charging system of example 7, wherein the historical vehicle charging data indicates one or more of historical vehicle characteristics, a number of historical vehicles charged, or historical vehicle charging schedules.
Example 10. The vehicle charging system of example 1, wherein the system is further configured to: charge a first vehicle of the one or more vehicles according to a first optimized charging scheme; and charge a second vehicle of the one or more vehicles according to a second charging scheme.
Example 11. The vehicle charging system of example 1, further comprising: an inter-charger connection communicatively connected to the battery and configured to provide a battery charging current to an additional vehicle charging system and to receive a battery charging input from the additional vehicle charging system via a direct connection with the additional vehicle charging system; and the system controller is further configured to: obtain the charging optimization data of the additional vehicle charging system; and generate the optimized charging scheme further based upon the charging optimization data of the additional vehicle charging system.
Example 12. A method for charging one or more vehicles according to an optimized charging scheme, the method comprising: receiving, via a power input port, input electric power from a power source; receiving and storing, via a battery, electric power derived from the input electric power received at the power input port; receiving, via a vehicle coupling, a charging current from one or more of the power source or the battery; obtaining, via one or more processors, charging optimization data of the vehicle charging system including one or more of: electrical characteristics of the vehicle charging system, environmental characteristics of the vehicle charging system, or scheduling data for the vehicle charging system; based upon the charging optimization data, generating, via a charging optimization engine stored one or more memories and executable by the one or more processors, the optimized charging scheme to optimize the charging current provided to the one or more vehicles and/or a number of vehicles to charge; providing, by the one or more processors, the optimized charging scheme to a system controller configured to control charging of the one or more vehicles via the vehicle coupling; and providing, via the vehicle coupling, the charging current to the one or more vehicles according to the optimized charging scheme.
Example 13. The method of example 12, wherein the power source is an alternating current (AC) power source, and the method further comprises: converting, via the vehicle coupling, the AC of the AC power source to direct current (DC); and providing, via the vehicle coupling, the DC as the charging current.
Example 14. The method of example 12, wherein the electrical characteristics of the vehicle charging system indicate a state of the input electrical power and/or the battery.
Example 15. The method of example 12, wherein the environmental characteristics of the vehicle charging system indicate one or more of: an ambient temperature, a humidity, a season, a time of day, a day of a year, or a type of weather.
Example 16. The method of example 12, wherein the vehicle charging schedule data indicates for the vehicles of the vehicle charging schedule one or more of: the number of vehicles, a state of charge of the vehicles, a battery capacity of the vehicles, or a rate of charge of the vehicles.
Example 17. The method of example 12, wherein the charging optimization engine includes a machine learning model trained using training data including historical vehicle charging system data and historical vehicle charging data, wherein the historical vehicle charging system data indicates one or more of historical electrical characteristics or historical environmental characteristics of the vehicle charging system; and the historical vehicle charging data indicates one or more of historical vehicle characteristics, a number of historical vehicles charged, or historical vehicle charging schedules.
Example 18. The method of example 12, further comprising: charging a first vehicle of the one or more vehicles according to a first optimized charging scheme; and charging a second vehicle of the one or more vehicles according to a second charging scheme.
Example 19. The method of example 12, further comprising: obtaining, via the one or more processors, the charging optimization data of an additional vehicle charging system, wherein an inter-charger connection is communicatively connected to the battery and configured to provide a battery charging current to the additional vehicle charging system and to receive a battery charging input from the additional vehicle charging system via a direct connection with the additional vehicle charging system; and generating, via the charging optimization engine, the optimized charging scheme is further based upon the charging optimization data of the additional vehicle charging system.
Example 20. A site charging system for charging one or more vehicles at a vehicle charging site according to an optimized charging scheme, the site charging system comprising: a plurality of vehicle charging systems at the vehicle charging site connected via a direct current (DC) bus, each vehicle charging system comprising: a power input port configured to receive input electric power from a power source; a battery configured to receive and store electric power derived from the input electric power received at the power input port; a vehicle coupling configured to: receive a charging current from one or more of the power source or the battery; and provide an electrical interconnect between the vehicle charging system and a vehicle in order to provide the charging current to the vehicle; and an inter-charger connection communicatively connected to the battery and configured to provide a battery charging current to one or more additional vehicle charging systems of the plurality of vehicle charging systems, and to receive a battery charging input from the one or more additional vehicle charging systems via a direct connection with the one or more additional vehicle charging systems; and a system controller configured to control charging of the one or more vehicles by the vehicle charging system; a charging optimization engine stored one or more memories and executable by one or more processors to generate an optimized charging scheme for charging the one or more vehicles via the vehicle charging system, the charging optimization engine being communicatively connected via one or more electronic communication connections to one or more of the system controller or a centralized management system; the centralized management system communicatively connected to the plurality of vehicle charging systems via the one or more electronic communication connections, the centralized management system comprising the one or more processors configured to: obtain charging optimization data of the vehicle charging site, the charging optimization data including one or more of: electrical characteristics of the vehicle charging site, environmental characteristics of the vehicle charging site, or scheduling data for the vehicle charging site; based upon the charging optimization data of the vehicle charging site, generate an optimized charging scheme to optimize the charging current provided to the one or more vehicles and/or a number of vehicles to charge; and provide the charging current to the one or more vehicles according to the optimized charging scheme.
Example 21. A charging system comprising: a local energy storage disposed at a charging site; an electric coupling configured to provide an electrical interconnect between the charging site and an electric vehicle (EV); and one or more controllers configured to: detect a condition related to availability of electrical energy at the charging station, in response to the detecting of the condition: estimate a number of EVs to which a charge remaining at the local energy storage is to be distributed within a certain time interval, initiate a charging session for transferring electric energy from the local energy storage to the EV, via the electric coupling, and limit an amount of electrical energy in the charging session in view of at least the estimated number of EVs.
Example 22. The charging system of claim 21, wherein to estimate the number of EVs for the certain time interval, the one of the one or more controllers determine how many reservations have been received for the charging site for the time interval.
Example 23. The charging system of claim 22, wherein the one of the one or more controllers are further configured to: transmit, to at least some of the customers associated with the reservations, estimates of amounts of electric charge available to the corresponding EVs.
Example 24. The charging system of claim 22, wherein the one of the one or more controllers are further configured to: transmit, to at least some of the customers associated with the reservations, notifications that charging will be limited.
Example 25. A method implemented by one or more controllers in a charging system, the method comprising: detecting a condition related to availability of electrical energy at a charging station equipped with a local energy storage; estimating a number of EVs to which a charge remaining at the local energy storage is to be distributed within a certain time interval; for a charging session in which electric energy is transferred from the local energy storage at the charging station to an EV via an electric coupling, limiting an amount of electrical energy in the charging session in view of at least the estimated number of EVs.
Example 26. The method of claim 25, wherein the estimating of the number of EVs for the certain time interval, includes applying historical data collected from a plurality of charging sites.
Example 27. The method of claim 26, further comprising: adjusting the estimated based on one or more of: (i) a time of day, (ii) a time of year, or (iii) current weather conditions.
Example 28. The method of claim 25, wherein the estimating the number of EVs for the certain time interval includes: determining how many reservations have been received for the charging site for the time interval.
Example 29. The method of claim 28, further comprising: transmitting, to at least some of the customers associated with the reservations, estimates of amounts of electric charge available to the corresponding EVs.
Example 30. The method of claim 28, further comprising: transmitting, to at least some of the customers associated with the reservations, notifications that charging will be limited.

The following additional considerations apply to the foregoing discussion.

These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

What is claimed is:

1. A charging system comprising:
a local energy storage disposed at a charging site;
an electric coupling configured to provide an electrical interconnect between the charging site and an electric vehicle (EV); and
one or more controllers configured to:
detect a condition related to availability of electrical energy at the charging station,
in response to the detecting of the condition:
estimate a number of EVs to which a charge remaining at the local energy storage is to be distributed within a certain time interval,
initiate a charging session for transferring electric energy from the local energy storage to the EV, via the electric coupling, and
limit an amount of electrical energy in the charging session in view of at least the estimated number of EVs.

2. The charging system of claim 1, further comprising:
a power input module at the charging station, the power input module coupled an external power source;
wherein the detecting of the condition related to the availability of electrical energy includes determining that the external power source is unavailable.

3. The charging system of claim 2, wherein the external power source is an AC grid.

4. The charging system of claim 1, wherein the one or more controllers are further configured to:
determine a current state of charge (SoC) of the local energy storage at a time of the detecting of the condition;
determine a minimal acceptable SoC of the local energy storage; and
divide a difference between the current SoC and the minimal SoC by the estimated number of EVs to determine an amount of charge to which the amount of electrical energy in the charging session is limited.

5. The charging system of claim 1, wherein the one or more controllers are further configured to:
limit the amount of electrical energy in the charging session in view of a time of day.

6. The charging system of claim 5, wherein to limit the amount of electrical energy in the charging session in view of the time of day, the one or more controllers are further configured to:
allocate a greater amount of the charge remaining at the local energy storage to the charging session in response to determining that the charging session is taking place during a peak usage period, and
allocate a smaller amount of the charge remaining at the local energy storage to a second charging session in response to determining that a second charging session is taking place outside of the peak usage period.

7. The charging system of claim 1, wherein the one or more controllers are further configured to:
limit the amount of electrical energy in the charging session in view of weather conditions.

8. The charging system of claim 1, wherein the one or more controllers are configured to allocate, to the charging session, a greater amount of electric energy than an average of the charge remaining at the local energy storage when the weather conditions are inclement.

9. The charging system of claim 1, wherein at least one of the one or more controllers resides in a centralized management system communicatively coupled to the charging site via a communication network.

10. The charging system of claim 1, wherein to estimate the number of EVs for the certain time interval, the one of the one or more controllers apply historical data collected from a plurality of charging sites.

11. The charging system of claim 10, wherein the one of the one or more controllers are further configured to adjust the estimated based on one or more of: (i) a time of day, (ii) a time of year, or (iii) current weather conditions.

12. A method implemented by one or more controllers in a charging system, the method comprising:
detecting a condition related to availability of electrical energy at a charging station equipped with a local energy storage;
estimating a number of EVs to which a charge remaining at the local energy storage is to be distributed within a certain time interval;
for a charging session in which electric energy is transferred from the local energy storage at the charging station to an EV via an electric coupling, limiting an amount of electrical energy in the charging session in view of at least the estimated number of EVs.

13. The method of claim 12, wherein:
the charging station includes a power input module coupled an external power source;
the detecting of the condition related to the availability of electrical energy includes determining that the external power source is unavailable.

14. The method of claim 13, wherein the external power source is an AC grid.

15. The method of claim 12, further comprising:
determining a current state of charge (SoC) of the local energy storage at a time of the detecting of the condition;
determining a minimal acceptable SoC of the local energy storage; and
dividing a difference between the current SoC and the minimal SoC by the estimated number of EVs to determine an amount of charge to which the amount of electrical energy in the charging session is limited.

16. The method of claim 12, further comprising:
limiting the amount of electrical energy in the charging session in view of a time of day.

17. The method of claim 16, wherein the limiting of the amount of electrical energy in the charging session in view of the time of day includes:
allocating a greater amount of the charge remaining at the local energy storage to the charging session in response to determining that the charging session is taking place during a peak usage period, and
allocating a smaller amount of the charge remaining at the local energy storage to a second charging session in response to determining that a second charging session is taking place outside of the peak usage period.

18. The method of claim 12, further comprising:
limiting the amount of electrical energy in the charging session in view of weather conditions.

19. The method of claim 18, further comprising:
allocating, to the charging session, a greater amount of electric energy than an average of the charge remaining at the local energy storage when the weather conditions are inclement.

20. The method of claim 12, wherein at least one of the one or more controllers resides in a centralized management system communicatively coupled to the charging site via a communication network.
